(19) United States
(12) Patent Application Publication
(10) Pub. No.: US 2003/0046536 A1
(43) Pub. Date: Mar. 6, 2003

(54) Consumer and revocation of their equipment

(76) Inventors: Alphons Antonius Maria Lambertus Bruekers, Eindhoven (NL); Antonius Adriaan Maria Staring, Eindhoven (NL)

Correspondence Address: U.S. Philips Corporation, 580 White Plains Road, Tarrytown, NY, 10591, US

(21) Appl. No.: 10/227,231

(22) Filed: Aug. 23, 2002

(30) Foreign Application Priority Data
Aug. 28, 2001 (EP) 012032246.2

(51) Int. Cl. H04L 9/00

(52) U.S. Cl. 713/158

(57) ABSTRACT

A system for allowing a potential buyer of second-hand of a CE device (60) to look up an identifier of the device (60) in a revocation list (55), in order to determine if the CE device (60) has been partially or full disabled as a result of revocation. The revocation list (55) may be accessible by a user on-line, e.g., on the Internet, or may be stored in a DVD. The CE device (60) may be equipped with a revocation status indicator 61 that, when activated by the user, causes the CE device (60) to access an on-line revocation list (55), look up its revocation status, and output its revocation status to the user. Alternatively, the CE device (60) may include a revocation status indicator (61) that accesses a tamper-resistant storage mechanism (63) in the CE device (60) to determine and output the revocation status.

### BACKGROUND OF THE INVENTION

1. Field of the Invention

The present invention relates to the use of revocation in consumer electronics equipment to prevent unauthorized copying and distribution of information, and more specifically, to a system and method for ensuring that consumers are aware of the revocation status of a piece of consumer electronics (CE) equipment before purchase.

2. Description of the Related Art

The protection of intellectual property (IP) in digital form is not a new issue. For years, much effort has been devoted into protecting software applications from illegal copying and distribution. However, the digitization has spread to many other types of IP. Audio content, such as music and songs, are now routinely recorded and distributed in the form of compact discs (CDs) and MP3 files. Movies are being recorded and distributed as digital versatile disks (DVDs) and as streaming video. Other types of IP that are widely distributed in digital form include images (photographs, paintings, etc.) and text (books, manuscripts, etc.).

One of the reasons for the large-scale digitization of IP is the fact that the quality of such digital content is much better than that of the same content recorded electronically in analog form. In addition, unlike content stored in analog form, digital content can be copied without suffering any deterioration in quality. Further, the recording media and the corresponding CE equipment needed to listen to or view such digital information has become increasingly more portable and convenient to the consumer. Also, the advent of the Internet allows digital content to be easily purchased at and distributed to the consumer's home.

Along with the increased digitization of IP there has been an increase in efforts to protect such content from illegal copying and distribution. This has resulted in the implementation of measures built into CE equipment, which uses or transports digital information, to prevent or reduce the production, transportation, and/or use of unauthorized copies of digital IP. For example, the Digital Transmission Copy Protection (DTCP) standard has been established through a collaboration of several CE manufacturing companies to protect content while it is being transmitted between digitally connected devices. FIG. 1 illustrates a configuration of CE devices 60, which communicate digital content according to the DTCP, via an IEEE 1394 serial bus, or other type of interconnection (e.g., USB or PCI).

The DTCP standard includes several mechanisms for preventing unauthorized copying and distribution of digital IP. According to DTCP, in order for a transmitting CE device 60 to transmit digital content to a recipient CE device 60 via interconnection 30, the transmitting device must verify that the recipient CE device 60 is authentic and encrypt the digital content for transmission.

If a public key encryption scheme is used, the recipient CE device 60 transmits a device certificate to the transmitting device during authentication. A device certificate contains amongst other things a unique identification number issued to the recipient device 60 by a central certifying authority 50. The transmitting CE device 60 may authenticate the device certificate via communications over a network 40, e.g., the Internet, with the certifying authority 50. Conversely, the certifying authority may periodically transmit a list of revoked device certificates over the network 40, or via other means such as pre-recorded physical media, to the transmitting CE device 60. The transmitted list is used by the transmitting device 60 to authenticate compliant recipient CE devices 60. In the configuration shown in FIG. 1, each CE device 60 may be able to communicate to the certifying authority 50 via the network 40. Alternatively, the CE devices 60 may be connected via a cable similar to interconnection 30 to another CE device, such as a PC, which is able to communicate with the certifying authority via network 40.

Device authentication may also be performed using a digital signature verification process that does not require network communications with a certifying authority 50. However, authentication does require communication between the transmitting CE device 60 and the owner of the certificate, i.e., the recipient CE device 60, namely to establish that the recipient device 60 has knowledge of the secret information for which the certificate vouches.

The transmitting device 60 further determines the public key of the recipient device 60 based on the device certificate. The recipient device 60 is able to decrypt messages transmitted by the transmitting device 60 using a private key that corresponds to the determined public key. In the most common case, the public key is used to agree on a temporary so-called session key that is subsequently used to encrypt the content. This latter encryption is performed using a symmetric cipher, which has a much higher performance than a public key algorithm. However, the public key itself may also be used by the transmitting device 60 to encrypt the digital content.

According to DTCP and similar copy protection standards, Copy Control Information (CCI) is embedded in the content to be transmitted. The CCI specifies the conditions under which copyrighted content can be copied. There are three distinct states of CCI, including “no copies permitted”, “one copy permitted”, and “unlimited copies permitted”. Compliant devices are configured to act in accordance with the CCI embedded in the content.

DTCP also provides for system renewability, which ensures long-term integrity of the system of connected devices through the revocation of non-compliant devices. In general, revocation of a device is the reduction or complete disablement of one or more of its functions if secret information (e.g., identifiers or decryption keys) of the device have been compromised, or discovered through hacking. For example, revocation of a CE device may place limits on the types of digital content that the device is able to decrypt and use. Alternatively, revocation may cause a piece of CE equipment to no longer perform certain functions, such as making copies, on any digital content it receives.

In copy protection schemes such as DTCP, revocation of a device may include revoking or invalidating the device certificate of a device, by placing it on a “blacklist,” or revocation list 55, at the certifying authority 50. This revocation list 55 may be periodically transmitted across the network 40, or by other means of distribution, to each CE device. As a result, no transmitting device will authenticate the certificate of or transmit content to the revoked device.

As mentioned above, a device certificate may be revoked if it is determined that the secret information of a compliant device, such as a decryption key, has been revealed through tampering with the internal hardware, because this information could potentially be used by a non-compliant recording device to authenticate itself to other compliant devices to receive and record digital content without authorization.

However, revocation by placing a device certificate in a revocation list 55 at a certifying authority 50 is not the only way that revocation can be implemented. Another type of revocation may cause a device to be unable to update its decryption keys as needed from certain content providers. Since the revoked device would not have access to the most recent decryption keys, it would be unable to decrypt and use the most recent digital content of these providers.

Revocation of a device may be enacted within the device itself. A special hardware device encased in tamper-resistant packaging may be implemented in a piece of CE equipment, which stores a unique identifier to be used for authentication with other devices or as part of the device's decryption key. Any detected tampering with the hardware device, or any detected misuse of the piece of equipment, may cause the hardware device to implement revocation by disabling certain functions, for example, by erasing its decryption key.

While revocation has been developed as a means to prevent the unauthorized copying or circulation of digital IP, this mechanism may also adversely affect honest consumers who do not intend to perform such unlawful actions. Since the functionality of revoked devices is reduced, revocation may substantially decrease the value of a piece of CE equipment. However, revocation of a device may not be readily apparent, and a malicious owner may try to sell a revoked device for full value, without telling the potential buyer that the device has been revoked.

Therefore, consumers that are shopping for a second-hand piece of CE equipment, such as a DVD player, may unwittingly purchase a DVD player that is no longer able to decrypt and play new DVD movies, because the DVD player has been revoked. Such revocation may not be readily apparent during testing of the DVD player, if an older DVD movie is being used to test the equipment. An unscrupulous seller may also discover other ways to manipulate the testing of such equipment to hide the fact that a DVD player, or other piece of equipment, has been revoked.

### SUMMARY OF THE INVENTION

The present invention helps prevent a consumer from unintentionally purchasing a piece of equipment that has been revoked due to its previous involvement in illegal or unauthorized activities. Specifically, the present invention allows for potential buyers to check for the revocation status of a CE device by accessing a database that contains a current list of revoked devices. These objects are achieved in a system as claimed in claim 1.

An exemplary embodiment of the present invention is directed to a revocation information system, which contains a database having a current list of revoked CE devices. A user terminal communicates with the revocation information system over a network. A potential buyer can determine whether or not that particular piece of equipment has been revoked, simply by inputting a unique identifier of the piece of equipment, such as a serial number that is permanently attached to its exterior, to the user terminal. The unique identifier is transmitted to the revocation information system, which accesses and transmits information regarding the revocation status of the corresponding piece of equipment back to the user terminal.

In a further exemplary embodiment, if the device corresponding to the unique identifier input by the user has been revoked, the revocation information system also transmits information indicating which functions or capabilities of the equipment have been disabled as a result of revocation.

Another exemplary embodiment is directed to a DVD disk, which contains an exhaustive and up-to-date list of revoked pieces of equipment. The list recorded on the DVD disk can be viewed by using a stand-alone DVD player connected to a television or other type of display device, or by a DVD-ROM drive connected to a PC. Such DVD disks can be distributed to interested consumers, or can be made accessible at a central location, e.g., a library or at various electronics stores.

Another exemplary embodiment is directed to a CE device, which is connected to the Internet or other type of network during normal operation, and can be used by a user to check its own revocation status. The CE device may include an output device for outputting the equipment's revocation status in response to activation of a switch, button, dial, etc. on the piece of equipment. In a further exemplary embodiment, the same mechanism used for checking the revocation status may also be used to implement revocation.

Another exemplary embodiment is directed to a CE device that includes a hardware device that stores information regarding any functionality of the equipment that has been reduced due to revocation. The piece of equipment may further include an output device for outputting this information to a user based on the activation of a switch, button, dial, etc. on the piece of equipment. Further, the hardware device used to store this information may include a tamper resistant mechanism to ensure that the stored information is not altered.

Advantages of the present invention will become more apparent from the detailed description provided hereafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below and the accompanying drawings, which are given for purposes of illustration only, and thus do not limit the present invention.

FIG. 1 illustrates a configuration where digital content is transmitted between CE devices according to the DTCP copy protection standard.

FIG. 2 illustrates an exemplary embodiment in which a user terminal is used to access the revocation status of a CE device from a remote revocation information system.

FIG. 3 illustrates an exemplary embodiment in which a CE device can check its revocation status by accessing the revocation list over a network.

FIG. 4 is a block diagram of a CE device according to an exemplary embodiment where the CE device includes a device for storing information regarding the device's revocation status.

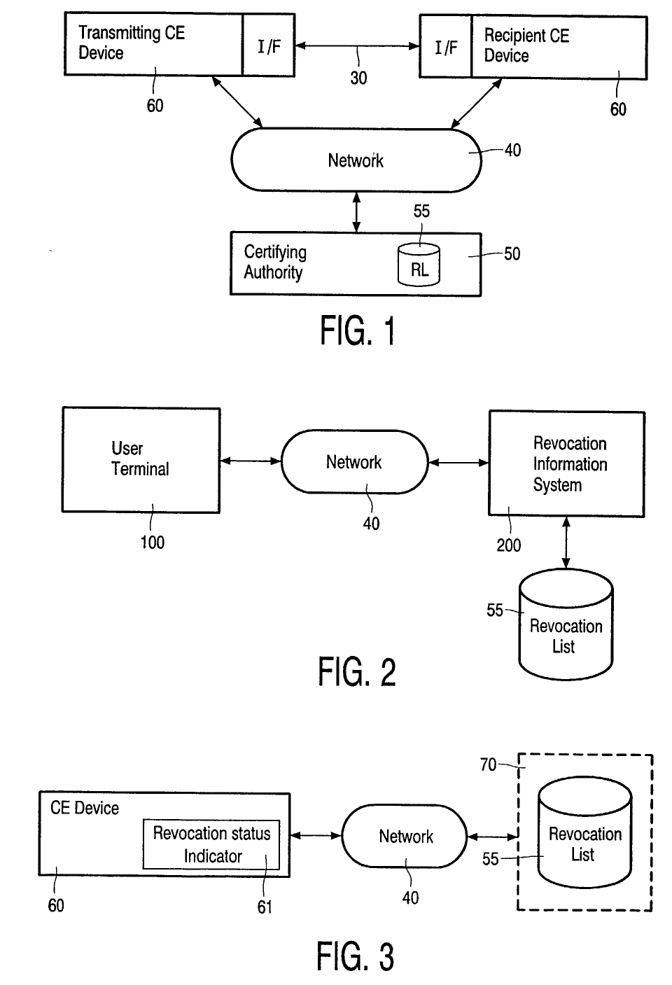

### DETAILED DESCRIPTION OF EXEMPLARY EMBODIMENTS

As described above, the present invention provides potential buyers with information regarding the revocation status of a CE device 60. A detailed description of exemplary embodiments of the present invention is provided below, which includes references to the figures. For the purposes of describing these embodiments, the term CE device 60 refers to any electronic device that can be used to record, transport, play or otherwise manipulate digital or analog content. Such devices include PCs, DVD players and recorders, CD players and recorders, cellular phones, videocassette recorders (VCRs), digital televisions, etc. Throughout the figures, components having similar functionality have been designated with identical reference numbers.

Revocation of CE device 60 generally occurs under either of two conditions: 1) the secret cryptographic keys of the CE device 60 have been exposed, as can be proven by presenting those keys to the device manufacturers, or 2) two or more CE devices 60 have embedded and employ exactly the same secret cryptographic keys, as can be proven from the fact that those devices authenticate themselves using exactly the same certificates (i.e., the same unique identification number and public key, which should be different for all devices).

In addition, content providers or CE manufacturers may actively search for cryptographic keys of CE devices 60 are published on the Internet, or some other public medium. The device certificates corresponding to the published keys may then be revoked.

It should further be noted that other methods of detecting the unauthorized acceptance, copying, or circulation of digital IP will be readily apparent to those of ordinary skill in the art.

FIG. 2 illustrates an exemplary embodiment of the present invention in which a user terminal is used to access the revocation status of a CE device 60 from a remote revocation information system. FIG. 2 shows a user terminal 100 connected to a revocation information system 200 via network 40. The revocation information system 200 includes a revocation list 55.

According to the embodiment illustrated in FIG. 2, a revocation information system 200 contains a revocation list 55, which is a list, or database, of unique identifiers of CE devices 60 that have been revoked. The revocation information site 200 is accessible by a user terminal 100, via communication network 40. In an exemplary embodiment, the revocation information site 200 comprises a website connected to the Internet, and the user terminal comprises a PC, or other type of device having Internet capabilities (i.e., a cellular phone or pager). In another exemplary embodiment, the revocation information site 200 may comprise any computer server, which can be accessed by the user's terminal over different types of computer networks, including networks comprising telephone lines, fiber optic lines, etc.

However, the revocation information site 200 is in no way limited to an Internet site or computer server. For example, the revocation information site may be an automated telephone system, which may be accessed by using a touch-tone telephone.

According to an exemplary embodiment, the revocation list 55 contained in the revocation information system 200 may be substantially identical to the revocation list 55 maintained by a certifying authority. For example, the revocation information system 200 may be a computer system maintained by a certifying authority 50. Alternatively, the revocation information system 200 may receive updates to its revocation list 55 transmitted by a certifying authority 50.

The user terminal 100 may include an interface that allows the user to enter the unique identifier corresponding to a CE device 60, such as a DVD player. The user interface may comprise a series of instructions or prompts displayed on a computer screen, or a series of audio instructions communicated over a touch-tone phone. In the exemplary embodiment where the revocation information system 200 comprises an Internet site, the user interface may comprise a web browser that displays an HTML or Java-based interface downloaded from the revocation information system 200.

According to an exemplary embodiment, the unique identifier comprises a set of alpha-numeric characters that is readily apparent to the user upon examination of the CE device 60, e.g., a serial number that is permanently engraved onto the device. However, the unique identifier may comprise other types of markings, such as UPC codes or the like, as will be contemplated by those of ordinary skill in the art.

The user terminal 100 then transmits the unique identifier input by the user to the revocation information system 200, which in turn searches its revocation list 55 for the unique identifier. If the unique identifier is indeed listed in the revocation list 55, the revocation information system 200 causes the user terminal 100 to display or output a message indicating that revocation has occurred to the corresponding CE equipment 60. Conversely, if the unique identifier is not contained in the revocation list 55, the revocation information terminal 200 causes the user terminal 100 to display a message indicating that no revocation has occurred to the CE equipment 60.

According to an exemplary embodiment, the revocation list 55 of the revocation information system 200 may include information regarding the types of functions disabled for each listed piece of CE equipment. Therefore, if the CE device 60 corresponding to the unique identifier entered by the user has indeed been revoked, the revocation information system 200 may additionally transmit information to the user terminal 100 specifying which functions have been partially or fully disabled by the revocation of the corresponding piece of CE equipment 60. This information may be conveyed to the potential buyer by the user interface of user terminal 100.

In another exemplary embodiment of the present invention, a revocation list 55 may be recorded onto a DVD. The revocation list 55 may be recorded onto the DVD and distributed by a certifying authority 55. Alternatively, the revocation list 55 may be recorded onto a DVD at a revocation information system 200, as described above with respect to a previous embodiment, maintained by an organization that has access to such information.

A DVD containing a revocation list 55 may be distributed directly to people who are looking to buy a second-hand CE device 60. The DVDs may be distributed via mail, or may be handed out (or sold) at a certain location, such as an electronics store or a vending machine. In an exemplary embodiment, a user may insert this DVD into a standard DVD player to view an exhaustive list of unique identifiers corresponding to CE devices 60 that have been subject to revocation. In such an embodiment, the unique identifiers will preferably contain alphabetical and/or numerical characters, and be sorted in alphabetical or numerical order in the revocation list. Therefore, a user will easily be able to determine whether or not a specific unique identifier is contained in the list.

In an alternative embodiment, the DVD may be configured for insertion into a DVD-ROM drive of a PC. In this embodiment, a software application running on the PC may allow the user to input a unique identifier and indicate to the user whether the input identifier is included in the revocation list 55.

In another exemplary embodiment, the DVD may be kept at a central location, where potential buyers may come to determine whether a certain CE device 60 has been revoked. The central location preferably includes a DVD player or PC that allows the user to access information from the stored revocation list 55. The central location that freely provides such information to the user (such as a library), or may be a place of business that provides information to the user in exchange for a fee.

In addition to the unique identifiers of revoked CE devices 60, the revocation list 55 recorded on a DVD may contain additional information with respect to each unique identifier, such as information regarding which functions have been disabled on the corresponding device 60.

According to another exemplary embodiment, other portable storage media or devices may be used to record and distribute revocation list 55. For example, a revocation list 55 may be recorded onto floppy disks, compact disks (CDs), smart cards, or any other type of storage media that is easily distributed to interested persons, as can be contemplated by those of ordinary skill in the art. In addition, the revocation list 55 may not necessarily be recorded on a storage medium to be distributed. For example, the revocation lists 55 may be distributed electronically directly to a user's PC via email or some other method known in the art.

FIG. 3 illustrates an exemplary embodiment of the present invention in which a CE device 60 is configured so that it can check its revocation status by accessing the revocation list over a network 40. The CE device 60 of this embodiment includes a revocation status indicator 61. FIG. 3 shows that the CE device is connected via network 40 to a system 70 containing a revocation list 55. The system 70 may be a computer system, such as a server, maintained at a certifying authority 50. Alternatively, the system revocation may be an information system 200 as discussed above with respect to other exemplary embodiments.

It should be noted that while FIG. 3 shows that the revocation list 55 is contained within system 70, the revocation list is in no way limited to a list, or database, which is actually stored within the system 70. The revocation list 55 may be stored at a location separate from system 70, from which the system 70 accesses the information stored in the revocation list 55 via a communication apparatus (e.g., cables or telephone wires). Typically, a revocation list 55 will also be stored (cached) within the CE device 60, and updated on each suitable opportunity via communications with system 70.

In FIG. 3, the network 40 may comprise the Internet, and the CE device 60 may be a device that is connected to the Internet during its normal operation. The CE device 60 may comprise a PC, cell phone, pager, or digital television system, which has built-in Internet capabilities. In an alternative embodiment, the CE device 60 may be configured so that it communicates with another CE device 60, which is normally connected to the Internet, via IEEE 1394 cables (or the like). In a further embodiment, the CE device 60 may be a device not normally connected to the Internet, such as a DVD player, which is specially configured to be able to access the Internet when needed.

The network 40 is not limited to the Internet and may be any other type of communications network to which the CE device 60 is connected during normal operation, or only as needed.

The revocation status indicator 61 of the CE device 60 includes an input mechanism, such as a switch or button, which a person can easily activate in order to receive information regarding the revocation status of the device 60.

According to a preferred embodiment, once activated, the revocation status indicator 61 causes the CE device 60 to transmit its unique identifier to system 70 via the network 40. In response, system 70 will compare the unique identifier of the CE device 60 to the identifiers stored in the revocation list 55. The system 70 then transmits revocation status information back to the CE device 60 indicating whether the unique identifier was contained in the list, and any other pertinent data obtained from the revocation list 55 (e.g., functions that have been disabled due to revocation).

Alternatively, activation of the revocation status indicator 61 may cause the CE device 60 to access and check for its unique identifier in a revocation list 55 that is cached within the device 60 itself. Further, such activation may cause the CE device 60 to establish communications with system 70 to perform an updating of the internally cached revocation list 55. The CE device 60 may then check its revocation status using the updated revocation list 55.

The revocation status indicator 61 may include, or be connected to, an output device (e.g., display screen) for presenting the user with the revocation status information. If the CE device 60 comprises a PC, the revocation status indicator 61 of the PC may include its own LCD screen for indicating the revocation status to the user. Alternatively, the revocation status indicator may cause the PC monitor or printer to output the revocation status information.

However, the revocation status indicator 61 may be configured such that it automatically causes the CE device 60 to retrieve the revocation status information from system 70, without activation by a user. The revocation status indicator 61 may be configured to periodically cause the CE device 60 to request its revocation status information from system 70, and store the information so that it can be instantly accessed and displayed when the user activates the input mechanism.

Further, the configuration shown in FIG. 3 can be used to implement revocation in the CE device 60. As mentioned above, system 70 may be maintained at the certifying authority 50. If the certifying authority 50 determines that the CE device 60 is being used for unauthorized activities, system 70 could record the retrieved identifier in the revocation list 55. In addition, system 70 could transmit a signal over network 40 to the CE device 60 causing a circuit or mechanism within the CE device 60 to partially (or fully) disable the functionality of the device 60.

The embodiment illustrated in FIG. 3, the user does not need to input a unique identifier. Therefore, in this embodiment, the unique identifier transmitted from the CE device 60 and the unique identifiers stored in the revocation list 55 is not necessarily a serial number or other type of identifier readily available to the owner or potential buyer of the CE device 60.

In order for the present invention to check the revocation status of a CE device 60 according to both secret identifiers stored within the device 60 and non-secret identifiers that can be determined by a user, the revocation list 55 of the present invention may contain two identifiers for each CE device 60.

The first identifier may comprise the secret identifier stored within the CE device 60, which may or may not be used the device's revocation. The second identifier may comprise an identifier corresponding to the same CE device 60, which can readily be determined through examination of the equipment, such as a serial number. The revocation list 55 provides a link between the first and second identifiers corresponding to each CE comparing either identifier to the revocation list 55.

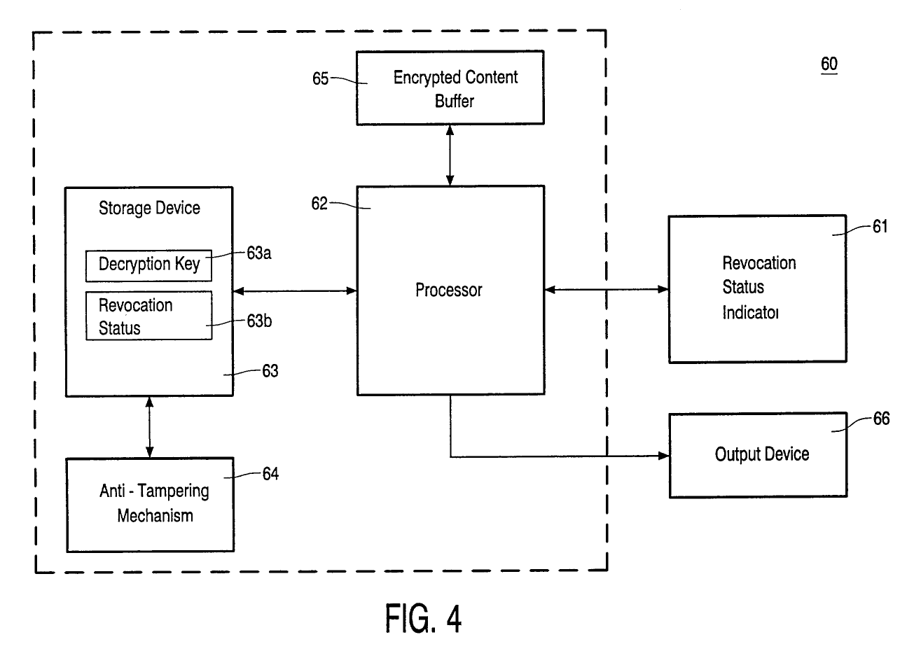

FIG. 4 is a block diagram of a piece of a CE device 60 according to an exemplary embodiment of the present invention where the CE device 60 includes a device for storing information regarding the device's revocation status. In this embodiment, no comparison of an identifier to the revocation list 55 is necessary.

FIG. 4 shows a revocation status indicator 61 connected to a processor 62 of the CE device 60. The processor 62 is connected to an encrypted content buffer 65, where digital content is temporarily stored after being received from a network 40 (not shown) or read from a storage media (e.g., DVD). The processor 62 is also connected storage device 63, which stores the decryption key in storage area 63a and the revocation status information in storage area 63b. Connected to the storage device 63 is an anti-tampering mechanism 64. The dotted line surrounds components of the CE device 60 to which access is restricted from a user or owner.

The CE device 60 of the embodiment illustrated in FIG. 4 will be described in more detail below. The revocation status information stored in storage area 63b indicates whether at any time the functionality of the device 60 was disabled as a result of revocation. The revocation status information may also include what functionality has been disabled in the CE device 60. When a user activates the revocation status indicator 61, using an input mechanism, the processor will retrieve the revocation status information from the storage device 63. The processor will then cause the revocation status information to be output on an output device of the revocation status indicator, or an output device 66 that is normally used to output digital content to the user.

Care must be taken to ensure that the owner cannot gain access to and change the revocation status information stored in storage device 65. The anti-tampering mechanism 64 prevents such unauthorized access. Preferably, the anti-tampering device 64 consists of a special hardware device, which detects any attempts to physically open or manipulate the storage device 63. The anti-tampering mechanism 64 may be configured to completely disable operation of the CE device 60 if such tampering is detected.

For example, the decryption key that is used by the processor 62 to decrypt the encrypted digital content may be stored in storage area 63a of storage device 63. As a result of any attempts to physically open or manipulate the storage device 63, the anti-tampering mechanism 63 may cause this decryption key to be erased. Accordingly, the processor 62 would be unable to decrypt and output the encrypted digital content stored in buffer 65. However, other mechanisms for preventing tampering with the storage device 63 may be used, as will be contemplated by those of ordinary skill in the art.

The present invention has been described with reference to the exemplary embodiments. As will be evident to those of ordinary skill in the art, various modifications of this invention can be made or followed in light of the foregoing disclosure without departing from the spirit and scope of the claims.

1. A system comprising:
a transmitting device for transmitting a unique identifier of a consumer electronics (CE) device over a network, said transmitting device including an output device;
a revocation status information system for receiving said transmitted unique identifier from said network, determining whether said transmitted unique identifier corresponds to one of a plurality of identifiers listed in a revocation list in order to determine a revocation status of said CE device, and transmitting information indicative of said revocation status back to said transmitting device,
wherein said output device outputs the determined revocation status to a user.

2. The system of claim 1, wherein said revocation status indicates whether one or more functions of said CE device have been partially or fully disabled in response to illegal or unauthorized operations performed using said CE device.

3. The system of claim 1, wherein said transmitting device comprises a revocation status indicator connected to said CE device.

4. The system of claim 3, wherein said revocation status indicator transmits said unique identifier in response to being activated by a user.

5. The system of claim 3, wherein said revocation status indicator automatically transmits said unique identifier over said network.

6. The system of claim 1, wherein said transmitting device comprises a user terminal including an input device for inputting said unique identifier, and
wherein said revocation information system determines a secret identifier corresponding to said external identifier and compares said secret identifier to said identifiers listed in said revocation list to determine said revocation status of said CE device.

7. A consumer electronics (CE) device comprising:
a storage device for storing revocation status information of said CE device; and
a revocation status indicator for causing said stored revocation status information to be accessed and output.

8. The CE device of claim 7, further comprising:
an anti-tampering mechanism for preventing physical access to said storage device.
